(19) United States
(12) Patent Application Publication
(10) Pub. No.: US 2023/0333608 A1
(43) Pub. Date: Oct. 19, 2023

(54) CASING STRUCTURE

(71) Applicant: 4plus international co., ltd, NEW TAIPEI CITY (TW)

(72) Inventors: JUI-YEN LEE, NEW TAIPEI CITY (TW); HONG-ZHANG YANG, NEW TAIPEI CITY (TW)

(21) Appl. No.: 18/300,353

(22) Filed: Apr. 13, 2023

(30) Foreign Application Priority Data
Apr. 18, 2022 (TW) 111203900

(51) Int. Cl. G06F 1/18

(52) U.S. Cl. CPC G06F 1/182

(57) ABSTRACT

A casing structure includes a plurality of first position-limiting rod elements, a main casing element, a cover element and a first shielding element. The main casing element has an accommodating space. The cover element is detachably connected to the main casing element. The first shielding element is detachably connected to the main casing element or the cover element. When the casing structure is in a storage state, the first position-limiting rod elements are located in the accommodating space. Therefore, the casing structure provided by the present invention can improve convenience during transportation.

### CROSS-REFERENCE TO RELATED PATENT APPLICATION

This application claims the benefit of priority to Taiwan Patent Application No. 111203900, filed on Apr. 18, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a casing structure, and more particularly to a casing structure that is convenient for transportation, assembly and detachment.

### BACKGROUND OF THE DISCLOSURE

Along with the development and progress of science and technology, computers have also become indispensable electronic products in modern life. People use computers not only at work, but also at school or in their private life.

The chassis of a general desktop computer is mostly an upright rectangle, which is assembled by connecting various boards through screw locking. Therefore, after the chassis is purchased from the manufacturer and then sold to the place where consumers use it, it will not only take up a lot of space in warehouses and freight vehicles in terms of transportation, but also increase the cost of packaging materials and transportation. Moreover, if consumers go to the store to purchase by themselves, it will be quite inconvenient to carry and transport.

In addition, there are few changes in the shape of the chassis at present, and there is usually no refreshing structural design in appearance.

Therefore, how to overcome the above-mentioned defects through the improvement of structural design has become one of the important issues to be solved in this field.

### SUMMARY OF THE DISCLOSURE

In response to the above-referenced technical inadequacy, the present disclosure provides a casing structure.

In order to solve the above-mentioned problems, one of the technical aspects adopted by the present disclosure is to provide a casing structure, which includes a plurality of first position-limiting rod elements, a main casing element having an accommodating space, a cover element detachably connected to the main casing element, and a first shielding element detachably connected to the main casing element or the cover element. When the casing structure is in a storage state, the first position-limiting rod elements are located in the accommodating space.

Therefore, in the casing structure provided by the present disclosure, by virtue of “a main casing element having an accommodating space,” “a cover element being detachably connected to the main casing element” and “a first shielding element being detachably connected to the main casing element or the cover element,” when the casing structure is in a storage state, the first position-limiting rod elements are located in the accommodating space so as to improve convenience during transportation.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a casing structure of a first embodiment of the present disclosure;

FIG. 2 is another schematic perspective view of the casing structure of the first embodiment of the present disclosure;

FIG. 3 is a first partial schematic exploded view of the casing structure of the first embodiment of the present disclosure;

FIG. 4 is a second partial schematic exploded view of the casing structure of the first embodiment of the present disclosure;

FIG. 5 is a schematic view showing a usage state of a main casing element of the casing structure of the first embodiment of the present disclosure;

FIG. 6 is a schematic assembled view of the casing structure of the first embodiment of the present disclosure;

FIG. 7 is a schematic view showing a usage state of the casing structure of the first embodiment of the present disclosure;

FIG. 8 is a schematic structural view of the casing structure of a second embodiment of the present disclosure;

FIG. 9 is a schematic assembled view of the casing structure of the second embodiment of the present disclosure; and

FIG. 10 is a schematic view showing a usage state of the casing structure of the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like elements throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various elements, signals or the like, which are for distinguishing one element/signal from another one only, and are not intended to, nor should be construed to impose any substantive limitations on the elements, signals or the like.

### First Embodiment

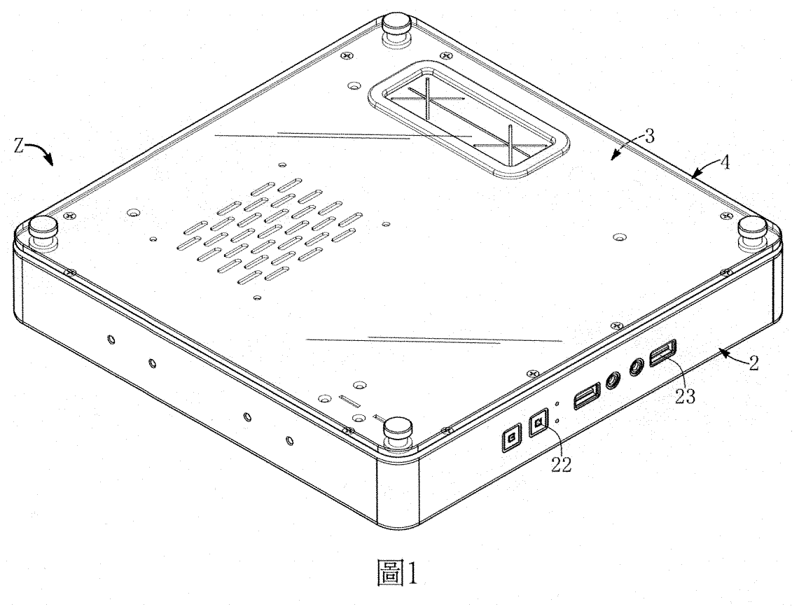

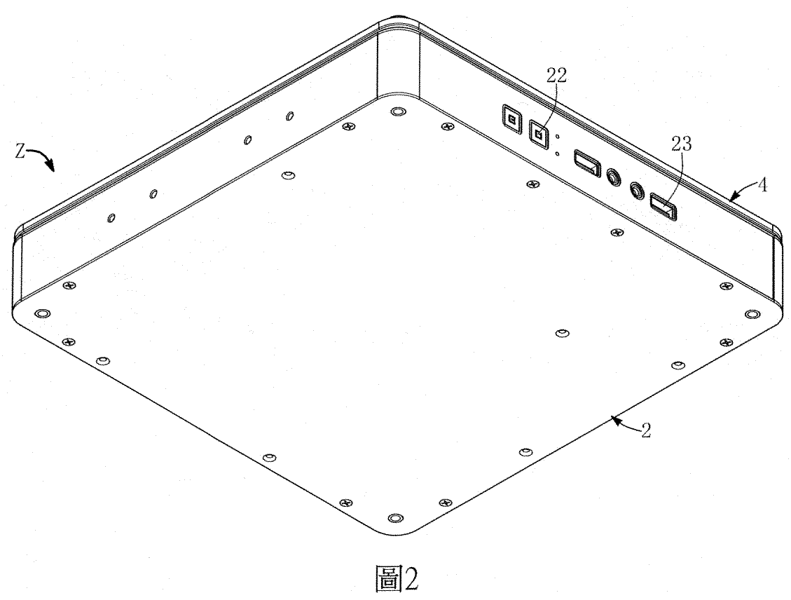

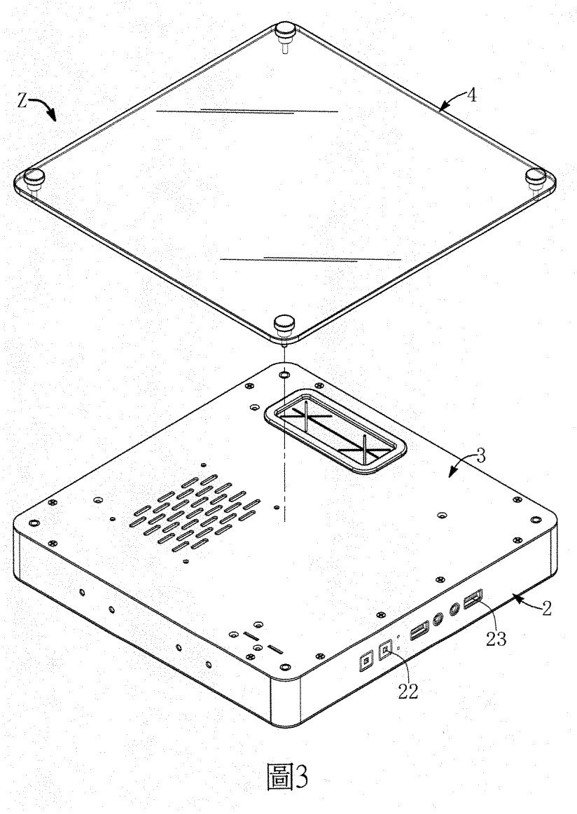

Referring to FIG. 1 to FIG. 7, which are a schematic perspective view viewed from an angle, a schematic perspective view viewed from another angle, a first partial schematic exploded view, a second partial schematic exploded view, a schematic view showing a usage state of a main casing element, a schematic assembled view, and a schematic view showing a usage state of the casing structure of the first embodiment of the present disclosure. As shown in the figures, the first embodiment of the present disclosure provides a casing structure Z (or a computer chassis structure), which includes a plurality of first position-limiting rod elements 1, a main casing element 2, a cover element 3 and a first shielding element 4. For example, the casing structure Z of the present disclosure can be a computer case including a detachable function and an assembling function, and can be applied to a desktop computer, but the present disclosure is not limited thereto.

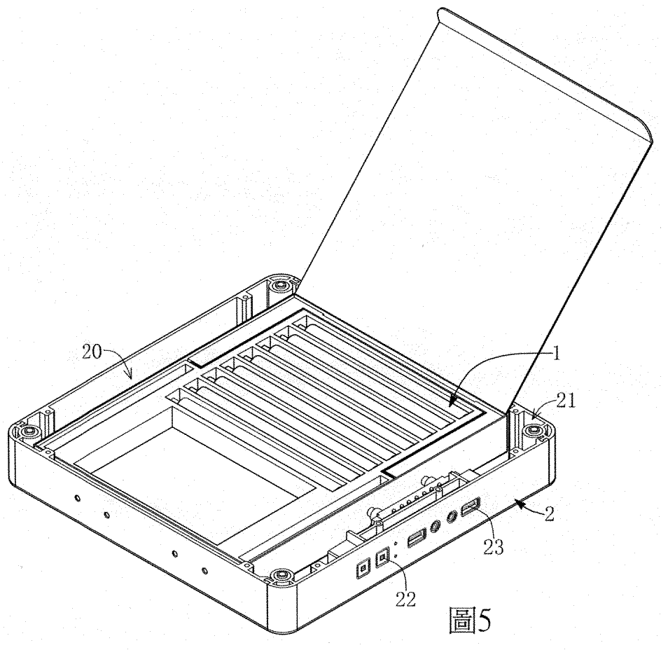

As shown in FIG. 5 to FIG. 7, the first position-limiting rod elements 1 of the present disclosure can be columnar structures, and the cross section of each first position-limiting rod element 1 can be circular, polygonal or other geometric shapes. Each first position-limiting rod element 1 can be made of metal or plastic, but the present disclosure is not limited thereto.

Next, as shown in FIG. 1 to FIG. 5, the main casing element 2 of the present disclosure has an accommodating space 20 (or a receiving space). For example, the main casing element 2 can be an open-type box structure, and the main casing element 2 can have an accommodating space 20 and an opening 21, and the opening 21 can communicate with the accommodating space 20. The main casing element 2 can be made of metal or plastic, but the present disclosure is not limited thereto. The outer shape of the main casing element 2 can be circular, polygonal or other geometric shapes.

Next, as shown in FIG. 1 to FIG. 4, the cover element 3 is detachably connected to the main casing element 2. For example, the cover element 3 can be a cover plate structure, and the cover element 3 can be detachably connected to the main casing element 2 by screw locking, mechanical engagement or other fixing methods. The cover element 3 can be made of metal or plastic, but the present disclosure is not limited thereto. The material of the cover element 3 and the main casing element 2 can be the same, but in practical application, the material of the cover element 3 and the main casing element 2 can also be different.

Next, as shown in FIG. 1 to FIG. 3, the first shielding element 4 is detachably connected to the main casing element 2 or the cover element 3. For example, the first shielding element 4 of the present disclosure can be a plate structure made of transparent material, but in practical application, the non-transparent material can also be used. The first shielding element 4 can be detachably connected to the main casing element 2 or the cover element 3 by screw locking, mechanical engagement or other fixing methods. In this embodiment, the installation of the first shielding element 4 on the cover element 3 is taken as an example, but the present disclosure is not limited thereto.

Therefore, when the casing structure Z is in a storage state, the first position-limiting rod elements 1 can be located in the accommodating space 20. For example, as shown in FIG. 1 to FIG. 5, before the casing structure Z of the present disclosure is assembled into a casing capable of accommodating a plurality of electronic devices, the casing structure Z is in a storage state, and the first position-limiting rod element 1 is accommodated inside the main casing element 2. Moreover, the cover element 3 covers the main casing element 2 and shields the opening 21, and the first shielding element 4 is connected to the cover element 3.

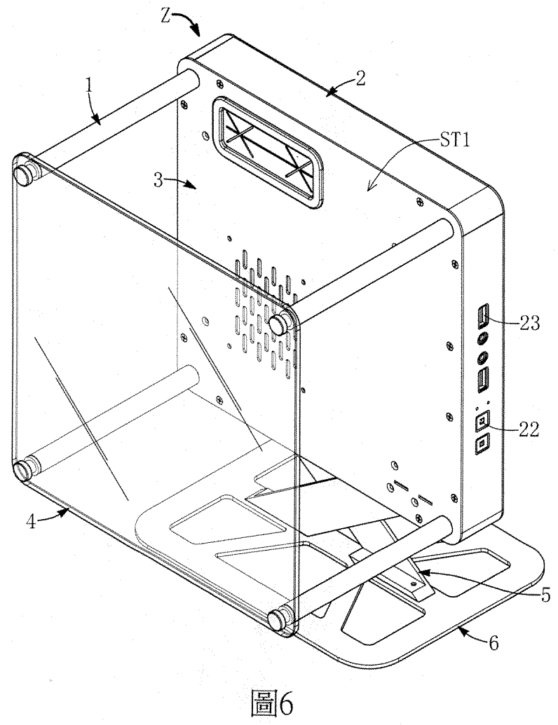

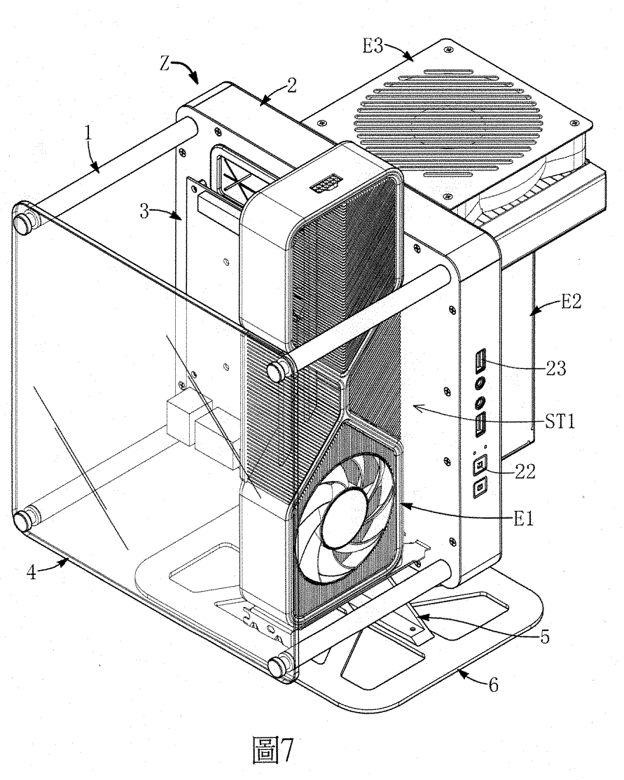

When the casing structure Z is in a usage state, one end of each of the first position-limiting rod elements 1 is connected to the main casing element 2, and the other end of each of the first position-limiting rod elements 1 is connected to the first shielding element 4, or one end of each of the first position-limiting rod elements 1 is connected to the cover element 3, and the other end of each of the first position-limiting rod elements 1 is connected to the first shielding element 4. For example, as shown in FIG. 6 and FIG. 7, when the casing structure Z is assembled by the user, the first shielding element 4 can be disassembled from the cover element 3, and then the first position-limiting rod elements 1 connect to the cover element 3 and the first shielding element 4, so that a first space ST1 can be formed between the cover element 3 and the first shielding element 4 for receiving an electronic device E1 (such as a display card, but the present disclosure is not limited thereto). Next, the user can install the circuit board (not shown in the figure) inside the main casing element 2 (i.e., inside the accommodating space 20), and install one or more electronic devices inside the first space ST1. The cover element 3 can be provided with a plurality of locking holes (not shown in the figure) for installing the electronic device E1.

Therefore, the casing structure Z of the present disclosure can not only provide suppliers with convenience for storage and transportation in a very small space through the above-mentioned structural design, but also provide convenience for consumers to carry and transport, and also provide convenience for users to assemble and disassembly, thereby improving the convenience of product delivery and the convenience of the product in use. Furthermore, the casing structure Z of the present disclosure can also provide a structural design with a sense of technology to enhance the visual effect of the appearance.

More particularly, the casing structure Z of the present disclosure can also include a support frame element 5 and a base seat element 6. When the casing structure Z is in the storage state, the support frame element 5 and the base seat element 6 are located in the accommodating space 20. Conversely, when the casing structure Z is in use, the support frame element 5 is detachably connected to one side of the main casing element 2, and the base seat element 6 is detachably connected to the support frame element 5.

For example, as shown in FIG. 6 and FIG. 7, the casing structure Z of the present disclosure can also include a stand mechanism, which can be used to support and elevate the main casing element 2. The stand mechanism includes a support frame element 5 and a base seat element 6. The support frame element 5 and the base seat element 6 can be made of metal or plastic, the support frame element 5 can be an X-shaped, I-shaped or other shaped plate structure, and the base seat element 6 can be a hollow plate structure, but it is not intended to be limit.

More particularly, the main casing element 2 can also include at least one switch element 22, which is disposed on the body of the main casing element 2. Moreover, the main casing element 2 may further include at least one connection interface element 23 disposed on the body of the main casing element 2.

For example, as shown in FIG. 1 to FIG. 7, a switch element 22 and a connection interface element 23 can be provided on the side of the main casing element 2. The switch element 22 can be a physical or touch switch element, and the connection interface element 23 can be a USB Type-A, USB Type-B or USB Type-C transmission interface, but the present disclosure is not limited thereto. When the number of the switch elements 22 is multiple, the switch elements 22 can be solid type, touch-type or a combination thereof. When the number of the connection interface elements 23 is multiple, the connection interface elements 23 can be USB Type-A, USB Type-B, USB Type-C or a combination thereof. Moreover, when a circuit board is installed in the main casing element 2, the switch element 22 and the connection interface element 23 can be electrically connected with the circuit board.

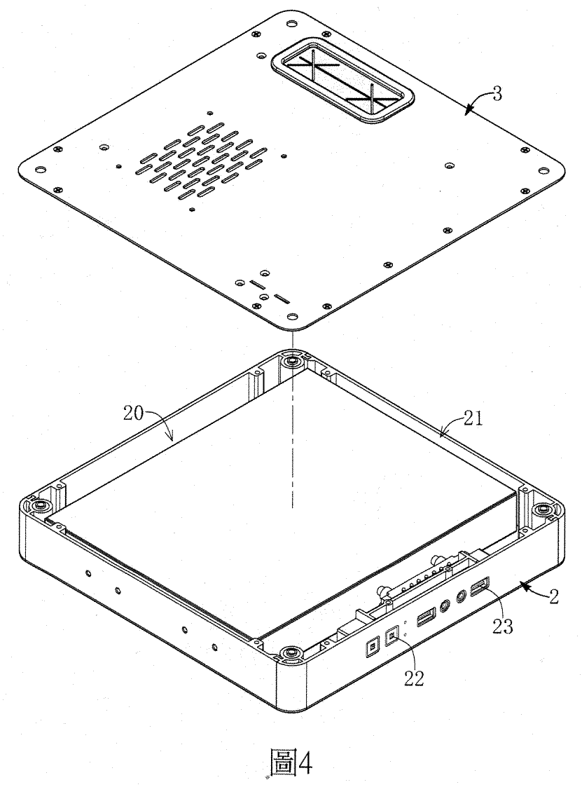

It is worth mentioning that, referring to FIG. 4 and FIG. 5, in other preferred embodiments, a plurality of first position-limiting rod elements 1 can also be placed in a storage box (not shown in the figure), and then place the storage box in the accommodating space 20, but the present disclosure is not limited thereto.

However, the above-mentioned example is only one of the feasible embodiments and is not intended to limit the present disclosure.

### Second Embodiment

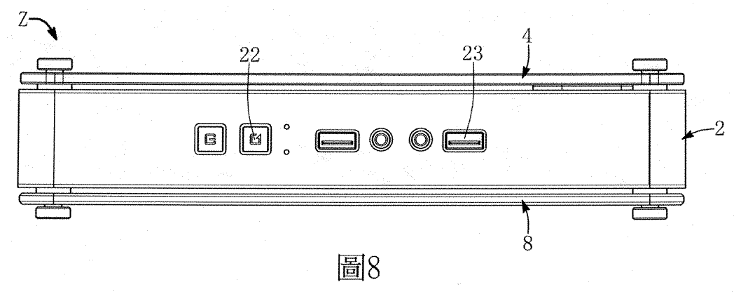

Referring to FIG. 8 to FIG. 10, which respectively are a structural diagram of the casing structure, a schematic view of the assembly state and a schematic view of the usage state of the second embodiment of the present disclosure, and referring to FIG. 1 to FIG. 7 together. As shown in the figure, the casing structure Z of this embodiment is substantially similar to the casing structure Z of the above-mentioned embodiment, so that the arrangement or operation of the same elements will not be repeated here. The difference between this embodiment and the casing structure Z of the above-mentioned first embodiment is that, in this embodiment, the casing structure Z further includes a plurality of second position-limiting rod elements 7 and a second shielding element 8. The second shielding element 8 is detachably connected to the main casing element 2, and the first shielding element 4 is detachably connected to the cover element 3.

For example, as shown in FIG. 8 to FIG. 10, the second position-limiting rod elements 7 can be a columnar structure, and the cross section of each second position-limiting rod element 7 can be circular, polygonal or other geometric shapes. Each second position-limiting rod element 7 can be made of metal or plastic, but the present disclosure is not limited thereto. The second shielding element 8 can be a plate structure made of non-transparent material, but in practical application, can also be made of transparent material. The second shielding element 8 can be detachably connected to the main casing element 2 or the cover element 3 by screw locking, mechanical engagement or other fixing methods. In this embodiment, the first shielding element 4 is installed on the cover element 3, and the second shielding element 8 is installed on the main casing element 2 as an example, but the present disclosure is not limited thereto. In other preferred embodiments, both the first shielding element 4 and the second shielding element 8 can also be mounted on one side of the main casing element 2 or one side of the cover element 3.

When the casing structure Z is in the storage state, the second position-limiting rod elements 7 are located in the accommodating space 20. For example, as shown in FIG. 4, FIG. 5 and FIG. 8, before the casing structure Z is assembled into a computer chassis capable of carrying a plurality of electronic devices, the first position-limiting rod elements 1 and the second position-limiting rod elements 7 can be accommodated inside the main casing element 2 (i.e., inside the accommodating space 20). Moreover, the cover element 3 covers the main casing element 2 and shields the opening 21, the first shielding element 4 is connected to the cover element 3, and the second shielding element 8 is connected to the main casing element 2.

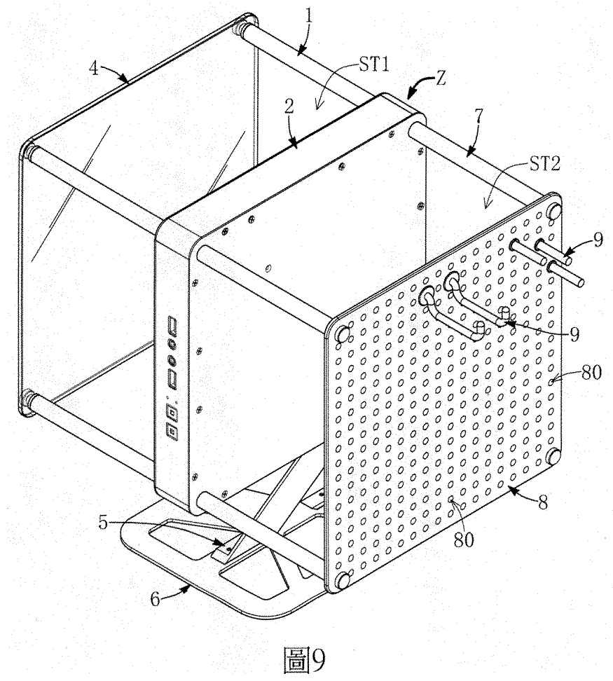

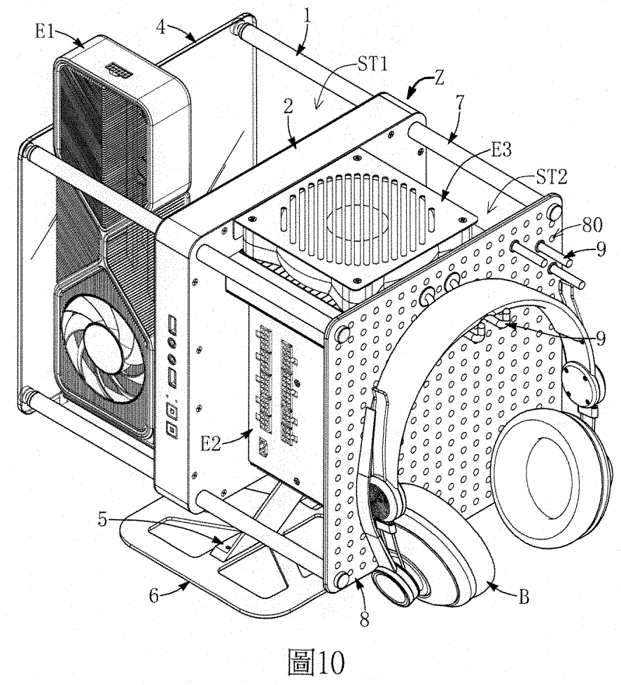

When the casing structure Z is in use, one end of each of the first position-limiting rod elements 1 is connected to the cover element 3, and the other end of each of the first position-limiting rod elements 1 is connected to the first shielding element 4, one end of each of the second position-limiting rod elements 7 is connected to the main casing element 2, and the other end of each of the first position-limiting rod elements 1 is connected to the second shielding element 8. For example, as shown in FIG. 9 and FIG. 10, when the user assembles the casing structure Z, the first shielding element 4 can be disassembled from the cover element 3, and then the first position-limiting rod elements 1 connect to the cover element 3 and the first shielding element 4, so that a first space ST1 can be formed between the cover element 3 and the first shielding element 4 for arranging the electronic device E1. Moreover, the user can detach the second shielding element 8 from the main casing element 2, and then connect the main casing element 2 and the second shielding element 8 through the second position-limiting rod elements 7, so that a second space ST2 can be formed between the casing element 2 and the second shielding element 8 for arranging electronic devices E2, E3 (such as a cooling fan and a power supply, but the present disclosure is not limited thereto). Next, the user can install the circuit board (not shown in the figure) in the accommodating space 20, and install a plurality of electronic devices in the first space ST1 and the second space ST2, respectively. Multiple locking holes (not shown in the figure) can be provided on the main casing element 2 and the cover element 3 for installing multiple electronic devices E1, E2, E3.

Furthermore, the casing structure Z may further include at least one positioning rod element 9. When the casing structure Z is in the storage state, at least one positioning rod element 9 is located in the accommodating space 20. In addition, the second shielding element 8 has a plurality of openings 80 penetrating therethrough. When the casing structure Z is in use, at least one positioning rod element 9 is detachably connected to one of the openings 80 of the second shielding element 8, and the at least one positioning rod element 9 is used for positioning at least one object B.

For example, as shown in FIG. 4, FIG. 5 and FIG. 10, the casing structure Z of the present disclosure can also include at least one positioning rod element 9. The positioning rod element 9 can be made of metal or plastic, but the present disclosure is not limited thereto. The positioning rod element 9 can be a columnar structure, or a positioning element with a hook-shaped design, and the cross section of the positioning rod element 9 can be circular, polygonal or other geometric shapes. Moreover, the second shielding element 8 may further have a plurality of openings 80.

Therefore, before the casing structure Z is assembled, the positioning rod element 9 can be accommodated in the accommodating space 20 of the main casing element 2 just like the first position-limiting rod element 1 and the second position-limiting rod element 7. When the casing structure Z is assembled, the positioning rod element 9 can be detachably connected to the openings 80 of the second shielding element 8 by screw locking, mechanical engagement or other fixing methods. Then, the user can place or fix the object B (such as earphones, but the present disclosure is not limited thereto) through the positioning rod element 9.

However, the above-mentioned example is only one of the feasible embodiments and is not intended to limit the present disclosure.

### Beneficial Effects of the Embodiments

In conclusion, one of the beneficial effects of the present disclosure is that in the casing structure provided by the present disclosure, by virtue of “a main casing element 2 having an accommodating space 20,” “a cover element 3 being detachably connected to the main casing element 2” and “a first shielding element 4 being detachably connected to the main casing element 2 or the cover element 3,” when the casing structure Z is in a storage state, the first position-limiting rod elements 1 are located in the accommodating space 20 so as to improve convenience during transportation.

Furthermore, with the above-mentioned structural design, before the casing structure Z of the present disclosure is assembled, the first position-limiting rod elements 1, the support frame element 5, the base seat element 6, the second position-limiting rod elements 7 and the positioning rod element 9 are placed inside the main casing element 2 (i.e., the accommodating space 20), so that the casing structure Z is small in size and does not take up much space when the casing structure Z is in a storage state. Therefore, the casing structure Z of the present disclosure can not only provide suppliers with convenience for storage and transportation in a very small space, but also provide convenience for consumers to carry and transport, and also provide convenience for users to assemble and disassembly, thereby improving the convenience of product delivery and the convenience of the product in use. In terms of assembly, the casing structure Z of the present disclosure can also provide users with convenient assembly and disassembly. At the same time, the casing structure Z of the present disclosure can also provide a structural design with a sense of technology to enhance the visual effect of the appearance.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A casing structure, comprising:
a plurality of first position-limiting rod elements;
a main casing element having an accommodating space;
a cover element detachably connected to the main casing element; and
a first shielding element detachably connected to the main casing element or the cover element;
wherein, when the casing structure is in a storage state, the first position-limiting rod elements are located in the accommodating space.

2. The casing structure according to claim 1, wherein, when the casing structure is in a usage state, one end of each of the first position-limiting rod elements is connected to the main casing element and another end of each of the first position-limiting rod elements is connected to the first shielding element, or one end of each of the first position-limiting rod elements is connected to the cover element and another end of each of the first position-limiting rod elements is connected to the first shielding element.

3. The casing structure according to claim 2, further comprising a support frame element and a base seat element; wherein, when the casing structure is in the storage state, the support frame element and the base seat element are located in the accommodating space.

4. The casing structure according to claim 3, wherein, when the casing structure is in the usage state, the support frame element is detachably connected to one side of the main casing element, and the base seat element is detachably connected to the support frame element.

5. The casing structure according to claim 1, further comprising:
a plurality of second position-limiting rod elements; and
a second shielding element detachably connected to the main casing element;
wherein the first shielding element is detachably connected to the cover element;
wherein, when the casing structure is in the storage state, the second position-limiting rod elements are located in the accommodating space.

6. The casing structure according to claim 5, wherein, when the casing structure is in the usage state, one end of each of the first position-limiting rod elements is connected to the cover element, another end of each of the first position-limiting rod elements is connected to the first shielding element, one end of each of the second position-limiting rod elements is connected to the main casing element, and another end of each of the first position-limiting rod elements is connected to the second shielding element.

7. The casing structure according to claim 5, further comprising at least one positioning rod element; wherein, when the casing structure is in the storage state, the at least one positioning rod element is located in the accommodating space.

8. The casing structure according to claim 7, wherein the second shielding element has a plurality of openings therethrough; wherein, when the casing structure is in the usage state, the at least one positioning rod element is detachably connected to one of the openings of the second shielding element, and the at least one positioning rod element is used for positioning at least one object.

9. The casing structure according to claim 1, wherein the main casing element further includes at least one switch element disposed on the main casing element.

10. The casing structure according to claim 1, wherein the main casing element further includes at least one connection interface element disposed on the main casing element.
